(19) United States
(12) Patent Application Publication
(10) Pub. No.: US 2024/0067560 A1
(43) Pub. Date: Feb. 29, 2024

(54) AQUEOUS TREATING MEDIUM AND METHODS FOR TREATING GLASS ARTICLES WITH THE SAME

(71) Applicant: CORNING INCORPORATED, Corning, NY (US)

(72) Inventors: Gabriel Pierce Agnello, Corning, NY (US); Dane Alphanso Christie, Painted Post, NY (US); Richard Michael Fiacco, Corning, NY (US); Eric Emil Leonhardt, Horseheads, NY (US); Adam Robert Sarafian, Corning, NY (US); Bryan Henry Smith, Painted Post, NY (US)

(21) Appl. No.: 18/237,733

(22) Filed: Aug. 24, 2023

Related U.S. Application Data
(60) Provisional application No. 63/400,846, filed on Aug. 25, 2022.

(51) Int. Cl. C03C 15/00; C03C 17/00; C03C 17/25

(52) U.S. Cl. CPC C03C 15/00; C03C 17/005; C03C 17/25; C03C 2217/213; C03C 2218/11

(57) ABSTRACT

An aqueous treating medium may include water; an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, wherein a concentration of the acid in the aqueous treating medium is from 0.5 M to 1.5 M; a salt, wherein a concentration of the salt in the aqueous treating medium is from greater than 0 M to 2 M; a fluoride-containing compound selected from the group consisting of: HF, NaF, NH₄HF₂, and combinations thereof, wherein a concentration of the fluoride-containing compound in the aqueous treating medium is from 0.026 M to 0.26 M; and silica, wherein the aqueous treating medium is saturated with silica.

### CROSS-REFERENCE TO RELATED APPLICATIONS

This application claims the benefit of priority under 35 U.S.C. § 119 of U.S. Provisional Application Ser. No. 63/400,846 filed on Aug. 25, 2022, the content of which is relied upon and incorporated herein by reference in its entirety.

### BACKGROUND

### Field

The present specification generally relates to aqueous media and, more specifically, to aqueous media for etching glass articles.

### Technical Background

Forming a textured surface on a glass article may increase the surface area of the glass article and allow for improved adhesion of a coating to the glass article. Various coatings may protect glass articles from damage induced by frictive contact. Methods for increasing the surface area of glass articles comprising silica may be limited by the ability to sustainably leach silica from the surface of a glass article. At a laboratory scale, mineral acid solutions, including hydrofluoric acid and boric acid may be used to leach silica from a glass surface; however, the use of these acids may not be suitable for manufacturing scale operations due to high capital costs and environmental concerns.

Accordingly, a need exists for alternative methods for forming a textured surface on glass articles that are more environmentally friendly, and suitable for use in manufacturing scale operations.

### SUMMARY

According to a first aspect of the present disclosure, an aqueous treating medium comprises water; an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, wherein a concentration of the acid in the aqueous treating medium is from 0.5 M to 1.5 M; a salt, wherein a concentration of the salt in the aqueous treating medium is from greater than 0 M to 2 M; a fluoride-containing compound selected from the group consisting of: HF, NaF, NH₄HF₂, and combinations thereof, wherein a concentration of the fluoride-containing compound in the aqueous treating medium is from 0.026 M to 0.26 M; and silica, wherein the aqueous treating medium is saturated with silica.

A second aspect of the present disclosure may include the first aspect, wherein the acid comprises citric acid.

A third aspect of the present disclosure may include either the first aspect or second aspect, wherein the salt comprises an alkali salt.

A fourth aspect of the present disclosure may include any of the first through third aspects, wherein the salt comprises sodium chloride.

A fifth aspect of the present disclosure may include any of the first through fourth aspects, wherein the salt comprises aluminum chloride.

A sixth aspect of the present disclosure may include any of the first through fifth aspects, wherein the salt comprises sodium chloride and aluminum chloride.

A seventh aspect of the present disclosure may include the sixth aspect, wherein the ratio of aluminum to sodium is from 1:1 to 3:1.

An eighth aspect of the present disclosure may include any of the first through seventh aspects, wherein the fluoride-containing compound comprises NH₄HF₂.

A ninth aspect of the present disclosure may include any of the first through eighth aspects, wherein the acid comprises citric acid, the salt comprises sodium chloride, aluminum chloride or a combination thereof, and the fluoride-containing compound comprises NH₄HF₂.

According to a tenth aspect of the present disclosure, a method for treating a glass article may include contacting a surface of a glass article with an aqueous treating medium to form a treated surface of the glass article. The glass article comprises silica. The aqueous treating medium comprises water; an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, wherein a concentration of the acid in the aqueous treating medium is from 0.5 M to 1.5 M; a salt, wherein a concentration of the salt in the aqueous treating medium is from greater than 0 M to 2 M; a fluoride-containing compound selected from the group consisting of: HF, NaF, NH₄HF₂, and combinations thereof, wherein a concentration of the fluoride-containing compound in the aqueous treating medium is from 0.026 M to 0.26 M; and silica, wherein the aqueous treating medium is saturated with silica. The aqueous treating medium etches silica from the surface of the glass article and deposits silica onto the surface of the glass article.

An eleventh aspect of the present disclosure may include the tenth aspect, wherein the glass article is formed from a Type I, Class A or a Type 1, Class B glass according to ASTM Standard E438-92.

A twelfth aspect of the present disclosure may include either the tenth aspect or eleventh aspect, wherein the glass article is formed from a borosilicate glass.

A thirteenth aspect of the present disclosure may include any of the tenth through twelfth aspects, wherein the glass article is an ion-exchange-strengthened glass article comprising a surface compressive stress layer.

A fourteenth aspect of the present disclosure may include any of the tenth through thirteenth aspects, wherein the glass article is a glass container comprising a sidewall at least partially enclosing an interior volume, the sidewall having an exterior surface.

A fifteenth aspect of the present disclosure may include the fourteenth aspect, wherein the aqueous treating medium contacts the exterior surface of the sidewall.

A sixteenth aspect of the present disclosure may include any of the tenth through fifteenth aspects, wherein contacting the glass article with the aqueous treating medium occurs for a time from 5 minutes to 72 hours.

A seventeenth aspect of the present disclosure may include any of the tenth through sixteenth aspects, wherein contacting the glass article with the aqueous treating medium occurs at a temperature from ambient temperature to 50° C.

An eighteenth aspect of the present disclosure may include any of the tenth through seventeenth aspects, wherein the method further comprises rinsing at least the treated surface of the glass article with deionized water.

A nineteenth aspect of the present disclosure may include any of the tenth through eighteenth aspects, wherein the treated surface of the glass article comprises silica deposits and the silica deposits have a height from greater than 0 nm to 20 nm and a diameter from greater than 0 nm to 50 nm.

A twentieth aspect of the present disclosure may include any of the tenth through eighteenth aspects, wherein the method further comprises applying a low-friction coating to the treated surface of the glass article.

According to a twenty-first aspect of the present disclosure, a method of making an aqueous treating medium comprises: heating a mixture comprising water; an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, a fluoride-containing compound selected from the group consisting of: HF, NaF, NH₄HF₂, and combinations thereof, and silica powder; to a temperature of from 25° C. to 95° C.; cooling the mixture to ambient temperature; filtering undissolved silica powder from the mixture; and adding one or more salts to the mixture to form the aqueous treating medium.

A twenty-second aspect of the present disclosure may include the twenty-first aspect, wherein the water is deionized water.

A twenty-third aspect of the present disclosure may include either the twenty-first aspect or twenty-second aspect, wherein the acid comprises citric acid.

A twenty-fourth aspect of the present disclosure may include any of the twenty-first through twenty-third aspects, wherein the salt comprises an alkali salt.

A twenty-fifth aspect of the present disclosure may include any of the twenty-first through twenty-fourth aspects, wherein the salt comprises sodium chloride.

A twenty-sixth aspect of the present disclosure may include any of the twenty-first through twenty-fifth aspects, wherein the salt comprises aluminum chloride.

A twenty-seventh aspect of the present disclosure may include any of the twenty-first through twenty-sixth aspects, wherein the salt comprises sodium chloride and aluminum chloride.

A twenty-eighth aspect of the present disclosure may include the twenty-seventh aspect, wherein the ratio of aluminum to sodium is from 1:1 to 3:1.

A twenty-ninth aspect of the present disclosure may include any of the twenty-first through twenty-eighth aspects, wherein the fluoride-containing compound comprises NH₄HF₂.

A thirtieth aspect of the present disclosure may include any of the twenty-first through twenty-ninth aspects, wherein the silica powder comprises silica particles having a particle size from 100 nm to 1000 nm.

A thirty-first aspect of the present disclosure may include any of the twenty-first through thirtieth aspects, wherein the acid comprises citric acid, the salt comprises sodium chloride, aluminum chloride or a combination thereof, and the fluoride containing compound comprises NH₄HF₂.

A thirty-second aspect of the present disclosure may include any of the twenty-first through thirty-first aspects, wherein a concentration of the acid in the aqueous treating medium is from 0.5 M to 1.5 M.

A thirty-third aspect of the present disclosure may include any of the twenty-first through thirty-second aspects, wherein a concentration of the salt in the aqueous treating medium is from greater than 0 M to 2 M.

A thirty-fourth aspect of the present disclosure may include any of the twenty-first through thirty-third aspects, wherein a concentration of the fluoride-containing compound in the aqueous treating medium is from 0.026 M to 0.26 M.

A thirty-fifth aspect of the present disclosure may include any of the twenty-first through thirty-fourth aspects, wherein the aqueous treating medium is saturated with silica.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a glass container, according to one or more embodiments described herein;

FIG. 2 depicts a scanning electron microscope (SEM) image of the surface of a vial etched by Sample 1 of an aqueous treating medium, according to the embodiment of Example 2;

FIG. 3 depicts a SEM image of the surface of a vial etched by Sample 9 of an aqueous treating medium, according to the embodiment of Example 2;

FIG. 4 depicts a SEM image of the surface of a vial etched by Sample 18 of an aqueous treating medium, according to the embodiment of Example 2;

FIG. 5 depicts a SEM image of the surface of a vial etched by Sample 19 of an aqueous treating medium, according to the embodiment of Example 2;

FIG. 6 depicts a confocal image of the surface of a vial etched by Sample 1 of the aqueous treating medium, according to the embodiment of Example 2;

FIG. 7 depicts a confocal image of the surface of a vial etched by Sample 9 of the aqueous treating medium, according to the embodiment of Example 2;

FIG. 8 depicts a confocal image of the surface of a vial etched by Sample 17 of the aqueous treating medium, according to the embodiment of Example 2;

FIG. 9 depicts a confocal image of the surface of a vial etched by Sample 24 of the aqueous treating medium, according to the embodiment of Example 2;

FIG. 10 depicts an atomic force microscope (AFM) image of the surface of a vial etched by Sample 1 of the aqueous treating medium, according to the embodiment of Example 2;

FIG. 11 depicts an AFM image of the surface of a vial etched by Sample 5 of the aqueous treating medium, according to the embodiment of Example 2;

FIG. 12 depicts an AFM image of the surface of a vial etched by Sample 11 of the aqueous treating medium, according to the embodiment of Example 2; and

FIG. 13 graphically depicts coefficient of friction data for coated vials, according to the embodiment of Example 3.

### DETAILED DESCRIPTION

Reference will now be made in detail to various embodiments of aqueous treating media for treating glass articles. Whenever possible, the same reference numerals will be used throughout the drawings to refer to the same or like parts. In embodiments, an aqueous treating medium may comprise water, an acid, a salt, a fluoride-containing compound, and silica. Embodiments of the aqueous treating medium may be used in a method for treating a glass article, where the method comprises contacting a surface of the glass article with the aqueous treating medium to form a treated surface of the glass article. Embodiments of the aqueous treating medium and methods for making and using such are described in further detail herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the singular forms “a,” “an” and “the” include plural referents unless the context clearly dictates otherwise. Thus, for example, reference to “a” component includes aspects having two or more such components, unless the context clearly indicates otherwise.

Glass articles, including glass containers, may be coated to protect the glass articles from damage, including damage caused by frictive contact between glass articles. Forming a textured surface on the glass article may improve the adhesion of a coating to that surface of the glass article. Conventional methods for texturing the surface of a glass article may include leaching silica from the surface of the glass article. At a laboratory scale, mineral acid solutions, such as solutions including hydrofluoric acid and boric acid, may be used to leach silica from a glass surface. However, the use of such solutions may not be suitable for producing textured surfaces on glass articles in a manufacturing scale operation due to high capital costs and environmental concerns. Accordingly, a need exists for alternative methods for forming a textured surface on glass articles that are more environmentally friendly and that are suitable for use in manufacturing scale operations. Embodiments of aqueous treating media described herein may be suitable for use in a manufacturing scale operation and may be more environmentally friendly that conventional etching solutions. Without intending to be bound by theory, embodiments of aqueous treating media described herein may be more environmentally friendly and compatible with manufacturing scale operations due to relatively low fluoride content.

In embodiments, the aqueous treating medium may comprise water. For example, without limitation, the water may include one or more of deionized water, tap water, distilled water, or fresh water. In embodiments, one or more constituents of the aqueous treating medium may be dissolved in the water.

The aqueous treating medium may comprise an acid. The acid may be selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof. In embodiments, the aqueous treating medium may comprise more than one acid. For example, the aqueous treating medium may comprise 2, 3, 4, 5, or more acids. In embodiments, the acid may comprise citric acid. In embodiments, the acid may consist essentially of or consist of citric acid.

In embodiments, a concentration of the acid in the aqueous treating medium may be from 0.5 molar (M) to 1.5 M. For example, without limitation, the concentration of the acid in the aqueous treating medium may be from 0.5 M to 1.5 M, from 0.7 M to 1.5 M, from 0.9 M to 1.5 M, from 1.1 M to 1.5 M, from 1.3 M to 1.5 M, from 0.5 M to 1.3 M, from 0.5 M to 1.1 M, from 0.5 M to 0.9 M, from 0.5 M to 0.7 M, or any combination or sub-set of these ranges.

Without intending to be bound by theory, when the acid comprises one or more of HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and the concentration of the acid is from 0.5 M to 1.5 M, the acid may be operable to dissolve silica from portions of the surface of the glass article without removing silica from other portions of the surface of the glass article. This may impart a texture to the surface of the glass article that contacts the aqueous treating medium without compromising the structure of the glass article.

The aqueous treating medium may comprise a salt. In embodiments, a concentration of the salt in the aqueous treating medium may be from greater than 0 M to 2.0 M. For example, the concentration of the salt in the aqueous treating medium may be from greater than 0 M to 2.0 M, from greater than 0 M to 1.8 M, from greater than 0 M to 1.6 M, from greater than 0 M to 1.4 M, from greater than 0 M to 1.2 M, from greater than 0 M to 1.0 M, from greater than 0 M to 0.8 M, from greater than 0 M to 0.6 M, from greater than 0 M to 0.4 M, from greater than 0 M to 0.2 M, from 0.2 M to 2.0 M, from 0.4 M to 2.0 M, from 0.6 M to 2.0M, from 0.8M to 2.0M, from 1.0 M to 2.0M, from 1.2M to 2.0M, from 1.4M to 2.0 M, from 1.6 M to 2.0 M, from 1.8 M to 2.0 M, or any combination or sub-set of these ranges.

In embodiments, the salt may comprise an alkali salt. As described herein, an “alkali salt” comprises an alkali metal, a Group 1 metal under IUPAC nomenclature, including lithium (Li), sodium (Na), potassium (K), rubidium (Rb), cesium (Cs), and francium (Fr). For example, without limitation, the salt may comprise sodium chloride or potassium chloride. In embodiments, the salt may comprise sodium chloride. In embodiments, the salt may comprise other metal salts in addition to the alkali salt, such as aluminum chloride. In embodiments, the aqueous treating medium may comprise multiple salts. For example, without limitation, the aqueous treating medium may comprise 2, 3, 4, 5, or more salts. In embodiments, the aqueous treating medium may comprise sodium chloride and aluminum chloride. In such embodiments, the molar ratio of aluminum to sodium may be from 1:1 to 3:1. For example, without limitation, the molar ratio of aluminum to sodium may be from 1:1 to 3:1, from 1.5:1 to 3:1, from 2:1 to 3:1, from 2.5:1 to 3:1, from 1:1 to 2.5:1 from 1:1 to 2:1, from 1:1 to 1.5:1 or any combination or sub-set of these ranges. Without intending to be bound by theory, inclusion of a salt in the aqueous treating medium may modulate the etching rate of glass articles treated by the medium.

Without intending to be bound by theory, the concentration of salt in the aqueous treating medium affects the extent to which the surface area of the glass article contacted by the aqueous treating medium is textured. For example, as the concentration of the salt in the aqueous treating medium increases, the density and size of silica deposits on the surface of a glass article treated with the aqueous treating medium increases.

The aqueous treating medium may further comprise a fluoride-containing compound. The fluoride-containing compound is selected from the group consisting of: HF, NaF, NH₄HF₂, and combinations thereof. In embodiments, the aqueous treating medium may comprise multiple fluoride containing compounds. For example, without limitation, the aqueous treating medium may comprise 2 or 3 fluoride-containing compounds. In embodiments, the fluoride-containing compound comprises NH₄HF₂. In embodiments, the fluoride-containing compound may consist essentially of NH₄HF₂ or consist of NH₄HF₂. Without intending to be bound by theory, the fluoride-containing compound may dissociate in the aqueous treating medium and act as a source of fluoride ions in the aqueous treating medium.

In embodiments, a concentration of the fluoride-containing compound in the aqueous treating medium is from 0.026 M to 0.26 M. For example, without limitation, the concentration of the fluoride-containing compound in the aqueous treating medium may be from 0.026 M to 0.26 M, from 0.05 M to 0.26 M, from 0.10 M to 0.26 M, from 0.15 M to 0.26 M, from 0.20 M to 0.26 M, from 0.026 M to 0.20 M, from 0.026 M to 0.15 M, from 0.026 M to 0.10 M, from 0.026 M to 0.05 M, or any combination or subset of these ranges.

Without intending to be bound by theory, the concentration of the fluoride-containing compound may affect the extent to which the surface area of a glass article contacted by the aqueous treating medium is textured. For example, the density and size of the silica deposits on the surface of a glass article contacted by the aqueous treating medium may increase as the concentration of the fluoride-containing compound in the aqueous treating medium increases.

The aqueous treating medium further comprises silica (SiO₂). In embodiments, the aqueous treating medium may be saturated with silica. As described herein, the aqueous treating medium may be saturated with silica when no more silica can be dissolved in the aqueous treating medium. The amount of silica necessary to saturate the aqueous treating medium may vary depending on the temperature of the aqueous treating medium, the pressure under which the aqueous treating medium is kept, and the concentrations of the acid, salt, and fluoride-containing compound in the aqueous treating medium.

Without intending to be bound by theory, the aqueous treating medium being saturated with silica allows silica to be both dissolved from the surface of a glass article with the aqueous treating medium and deposited onto the surface of the glass article from the aqueous treating medium, thereby imparting texture to the surface of the glass article. This effect may occur because local unsaturation of silica in the aqueous treating medium may result in a portion of the surface of the glass article dissolving, while local supersaturation of silica in the aqueous treating medium may result in the deposition of silica onto the surface of the glass article from the aqueous treating medium. Dissolution of silica from the surface of the glass article may leave a depression in the surface of the glass article, and deposition of silica onto the surface of the glass article may result in a protrusion on the surface of the glass article. Accordingly, a glass article comprising silica may be textured by exposing the glass article to an aqueous treating medium that is saturated with silica.

The description now turns to methods for making the aqueous treating medium. In embodiments, a method for making an aqueous treating medium may comprise heating a mixture comprising water, an acid, and silica powder to a temperature of from 25° C. to 95° C. For example, the mixture may be heated to a temperature of from 25° C. to 95° C., from 35° C. to 95° C., from 45° C. to 95° C., from 55° C. to 95° C., from 65° C. to 95° C., from 75° C. to 95° C., from 85° C. to 95° C., from 25° C. to 85° C., from 25° C. to 75° C., from 25° C. to 65° C., from 25° C. to 55° C., from 25° C. to 45° C., from 25° C. to 35° C., or any combination or subset of these ranges. Without intending to be bound by theory, heating the mixture may increase the solubility of silica in the mixture and the rate of dissolution of the silica powder in the mixture.

The water may be any water described hereinabove with regards to the aqueous treating medium. In embodiments, the water may be deionized water. As previously described, the acid may be selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof.

In embodiments, the silica powder may comprise silica particles having an average particle size from 100 nm to 1000 nm. For example, without limitation, the silica particles may have an average particle size from 100 nm to 1000 nm, from 300 nm to 1000 nm, from 500 nm to 1000 nm, from 700 nm to 1000 nm, from 900 nm to 1000 nm, from 100 nm to 800 nm, from 100 nm to 600 nm, from 100 nm to 400 nm, from 100 nm to 200 nm, or any combination or subset of these ranges. Without intending to be bound by theory, when the silica particles have an average particle size from 100 nm to 1000 nm the silica may readily dissolve into the aqueous treating medium and any undissolved particle may be filtered from the aqueous treating medium once the aqueous treating medium is saturated with silica.

The method for making the aqueous treating medium may include cooling the mixture to ambient temperature following heating. Cooling may be achieved by any suitable means including but not limited to active cooling and passive cooling. In embodiments, the mixture is cooled to ambient temperature passively. Without intending to be bound by theory, as the mixture cools the solubility of silica in the mixture decreases. Dissolving silica into the mixture at an elevated temperature and subsequently cooling the mixture may facilitate the production of a mixture that is saturated in silica at the cooler temperature. It should be noted that silica may precipitate from the mixture during the cooling step.

In embodiments, the method for making the aqueous treating medium may include filtering undissolved silica powder from the mixture. The undissolved silica powder may be filtered by any filtration means operable to remove the undissolved silica particles having an average particle size from 100 nm to 1000 nm. For example, without limitation, suitable filtration means may include filter paper and cheese cloth, depending on the size of particles being removed from the aqueous treating medium. Without intending to be bound by theory, unfiltered silica particles may contact the glass surface, resulting in visible defects in the glass surface. Filtering excess silica particles from the aqueous treating medium may prevent contact between the silica particles and a glass surface contacted with the aqueous treating medium.

The method for making the aqueous treating medium may include adding one or more salts to the mixture to form the aqueous treating medium. The salt may be any salt described hereinabove with respect to the composition of the aqueous treating medium. In embodiments, the salt may comprise sodium chloride, aluminum chloride, or a combination thereof. It should be understood that embodiments of the aqueous treating medium formed by the method described herein may have a composition as previously described herein.

The description now turns to methods for treating a glass article with an aqueous treating medium. In embodiments, methods for treating a glass article may comprise contacting a surface of a glass article with an aqueous treating medium, as described hereinabove. In embodiments, the glass article comprises silica. The aqueous treating medium may etch silica from the surface of the glass article and deposit silica onto the surface of the glass article to impart a texture to a treated surface of the glass article.

In embodiments, the glass article may be formed from glass compositions which meet the criteria for Type I, Class A (Type IA) or Type I, Class B (Type IB) glasses under ASTM Standard E438-92 (2011) entitled “Standard Specification for Glasses in Laboratory Apparatus”. In embodiments, the glass may be a borosilicate glass meeting these criteria or an aluminosilicate glass meeting the same criteria (other than composition) Borosilicate glasses meet the Type I (A or B) criteria and are routinely used for pharmaceutical packaging. Examples of borosilicate glass include, without limitation, Corning® Pyrex® 7740, 7800, Wheaton 180, 200, and 400, Schott Duran®, Schott Fiolax®, KIMAX® N-51A, Gerresheimer GX-51 Flint and others. Examples aluminosilicate glass include Valor® from Corning Incorporated. It should be understood that the methods described herein may be used with other glass compositions, including glass borosilicate and aluminosilicate glasses that do not meet the aforementioned criteria.

In embodiments, the glass article may be an ion-exchange-strengthened glass article comprising a surface compressive stress layer. In embodiments, the ion-exchange-strengthened glass article may have a compressive stress of greater than or equal to about 250 MPa, 300 MPa or even greater than or equal to about 350 MPa at the surface of the ion-exchange-strengthened glass article. In embodiments, the compressive stress may be greater than or equal to about 400 MPa at the surface of the glass or even greater than or equal to about 450 MPa at the surface of the glass. In some embodiments, the compressive stress may be greater than or equal to about 500 MPa at the surface of the glass or even greater than or equal to about 550 MPa at the surface of the glass. In still other embodiments, the compressive stress may be greater than or equal to about 650 MPa at the surface of the glass or even greater than or equal to about 750 MPa at the surface of the glass. The compressive stress in the ion-exchange-strengthened glass article generally extends to a depth of layer (DOL) of at least about 10 m. In some embodiments, the ion-exchange-strengthened glass article may have a depth of layer greater than about 25 m or even greater than about 50 m. In some other embodiments, the depth of the layer may be up to about 75 m or even about 100 m. The ion-exchange strengthening may be performed in a molten salt bath maintained at temperatures from about 350° C. to about 600° C. To achieve the desired compressive stress, the glass article may be immersed in the salt bath for less than about 30 hours or even less than about 20 hours. In embodiments, the glass article may be immersed for less than about 15 hours or even for less than about 12 hours. In other embodiments, the glass article may be immersed for less than about 10 hours. For example, in one embodiment the glass article is immersed in a 100% KNO₃ salt bath at about 450° C. for about 5 hours to about 8 hours in order to achieve the desired depth of layer and compressive stress.

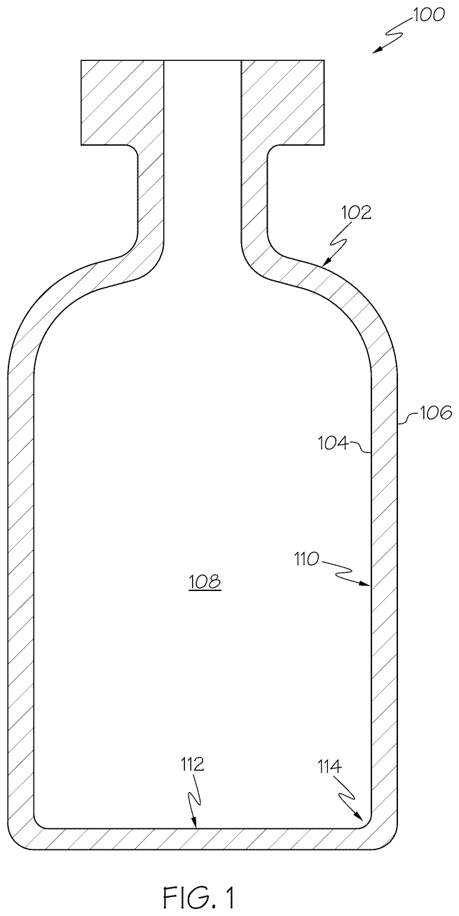

In embodiments, the glass article may be a glass container comprising a glass body at least partially enclosing an interior volume, the sidewall having an exterior surface. Referring to FIG. 1 by way of example, a glass container, such as a glass container for storing a pharmaceutical composition, is schematically depicted in cross section. The glass container 100 generally comprises a glass article with a glass body 102. The glass body 102 extends between an interior surface 104 and an exterior surface 106 and generally encloses an interior volume 108. In the embodiment of the glass container 100 shown in FIG. 1, the glass body 102 generally comprises a wall portion 110 and a floor portion 112. The wall portions 110 and the floor portion 112 may generally have a thickness in a range from about 0.5 mm to about 3.0 mm. The wall portion 110 transitions into the floor portion 112 through a heel portion 114. While the glass container 100 is depicted in FIG. 1 as having a specific shape form (i.e., a vial), it should be understood that the glass container 100 may have other shape forms, including, without limitation, vacutainers, cartridges, syringes, syringe barrels, ampoules, bottles, flasks, phials, tubes, beakers, or the like.

In embodiments, the aqueous treating medium may contact the exterior surface 106 of the glass body 102. In embodiments, the aqueous treating medium may be prevented from contacting the interior surface 104 of the glass article. This may be accomplished by plugging or otherwise closing an opening of the glass container to prevent the aqueous solution from entering the interior volume 108 of the glass container 100.

In embodiments, contacting the glass article with the aqueous treating medium may occurs for a time from 5 minutes to 72 hours. For example, without limitation, contacting the glass article with the aqueous treating medium may occur for a time from 5 minutes to 72 hours, from 30 minutes to 72 hours, from 1 hour to 72 hours, from 6 hours to 72 hours, from 12 hours to 72 hours from 24 hours to 72 hours, from 48 hours to 72 hours, from 5 minutes to 48 hours, from 5 minutes to 24 hours, from 5 minutes to 12 hours, from 5 minutes to 6 hours, from 5 minutes to 1 hour, from 5 minutes to 30 minutes, or any combination or subset of these ranges.

In embodiments, contacting the glass article with the aqueous treating medium may occur at a temperature from ambient temperature to 50° C. For example, without limitation, contacting the glass article with the aqueous treating medium may occur at a temperature from ambient temperature to 50° C., from 20° C. to 50° C., from 25° C. to 50° C., from 30° C. to 50° C., from 35° C. to 50° C., from 35° C. to 50° C., from 40° C. to 50° C., from 45° C. to 50° C., from 20° C. to 45° C., from 20° C. to 40° C., from 20° C. to 35° C., from 20° C. to 30° C., from 20° C. to 25° C. or any combination or subset off these ranges. As described herein, “ambient temperature” refers to the temperature of the environment in a particular place. For example, without limitation, ambient temperature may be about 20° C. Without intending to be bound by theory, the temperature and time at which the glass article is contacted with the aqueous treating medium to achieve a desired level of surface roughening may be inversely related. For example, as the temperature at which the glass article and aqueous treating medium are contacted is increased, the time for which the glass article and the aqueous treating medium are contacted may be decreased, to achieve a desired level of surface roughening.

In embodiments, the method for treating a glass article may further comprise rinsing at least the treated surface of the glass article with water. The water may be deionized water in some embodiments. Rinsing the surface of the glass article may remove aqueous treating medium from the treated surface of the glass article, stopping any etching of silica from the treated surface of the glass article or stopping any deposition of silica onto the treated surface of the glass article.

In embodiments, the treated surface of the glass article may comprise silica deposits. The silica deposits may be dome shaped in one or more embodiments. The silica deposits may have a height from greater than 0 nm to 20 nm. For example, without limitation, the silica deposits may have a height from greater than 0 nm to 20 nm, from 5 nm to 20 nm, from 10 nm to 20 nm, from 15 nm to 20 nm, from greater than 0 nm to 15 nm, from greater than 0 nm to 10 nm, from greater than 0 nm to 5 nm, or any combination or sub-set of these ranges. The height of a silica deposit may be measured by atomic force microscopy. The height of a silica deposit may be relative to a base surface of the glass article. In embodiments, the silica deposits may have a diameter from greater than 0 nm to 50 nm. For example, without limitation, the silica deposits may have a diameter from greater than 0 nm to 50 nm, from 10 nm to 50 nm, from 20 nm to 50 nm, from 30 nm to 50 nm, from 40 nm to 50 nm, from greater than 0 nm to 40 nm, from greater than 0 nm to 30 nm, from greater than 0 nm to 20 nm, from greater than 0 nm to 10 nm, or any combination or subset of these ranges. The diameter of a silica deposit may be measured by atomic force microscopy. Without intending to be bound by theory, the silica deposits on the treated glass surface may be bound to the treated glass surface by a combination of Van der Waals forces, hydrogen bonding, and capillary forces.

The method for treating the surface of a glass article may further comprise applying a low-friction coating to the treated surface of the glass article. The low-friction coating may be applied to the treated surface by any suitable means, such as spraying the low-friction coating onto the treated surface. The low-friction coating decreases the coefficient of friction of the portion of the body with the coating and, as such, decreases the occurrence of abrasions and surface damage on the outer surface of the glass body. In essence, the coating allows the container to “slip” relative to another object (or container) thereby reducing the possibility of surface damage on the glass. Moreover, the low-friction coating also cushions the body of the glass container, thereby lessening the effect of blunt impact damage to the glass container. Suitable coatings are disclosed in U.S. patent application Ser. No. 13/780,754 filed Feb. 28, 2013 and U.S. patent application Ser. No. 14/075,630 filed on Nov. 8, 2013, each of which is incorporated herein by reference in their entireties. However, it should be understood that other types of coatings may be applied to the treated surface of the glass article.

As referenced above, the coating may have a low coefficient of friction. The coefficient of friction (μ) of the portion of the coated glass container with the low-friction coating may have a lower coefficient of friction than a surface of an uncoated glass container formed from a same glass composition. A coefficient of friction (μ) is a quantitative measurement of the friction between two surfaces and is a function of the mechanical and chemical properties of the first and second surfaces, including surface roughness, as well as environmental conditions such as, but not limited to, temperature and humidity. As used herein, a coefficient of friction measurement for a coated glass container is reported as the coefficient of friction between the outer surface of a first glass container and the outer surface of second glass container which is identical to the first glass container, wherein the first and second glass containers have the same body and the same coating composition (when applied) and have been exposed to the same environments prior to fabrication, during fabrication, and after fabrication. Unless otherwise denoted herein, the coefficient of friction refers to the maximum coefficient of friction measured with a normal load of 30 N measured on a vial-on-vial testing jig. However, it should be understood that a coated glass container which exhibits a maximum coefficient of friction at a specific applied load will also exhibit the same or better (i.e., lower) maximum coefficient of friction at a lesser load. For example, if a coated glass container exhibits a maximum coefficient of friction of 0.5 or lower under an applied load of 50 N, the coated glass container will also exhibit a maximum coefficient of friction of 0.5 or lower under an applied load of 25 N.

In the embodiments described herein, the coefficient of friction of the glass containers (both coated and uncoated) is measured with a vial-on-vial testing jig. This measurement technique and corresponding device are described in U.S. patent application Ser. No. 13/780,754 filed on Feb. 28, 2013, which is incorporated herein by reference in its entirety.

In the embodiments described herein, the portion of the coated glass container with the low-friction coating has a coefficient of friction of less than or equal to about 0.7 relative to a like-coated glass container, as determined with the vial-on-vial testing jig. In other embodiments, the coefficient of friction may be less than or equal to about 0.6, or even less than or equal to about 0.5. In some embodiments, the portion of the coated glass container with the low-friction coating has a coefficient of friction of less than or equal to about 0.4, or even less than or equal to about 0.3. Coated glass containers with coefficients of friction less than or equal to about 0.7 generally exhibit improved resistance to frictive damage and, as a result, have improved mechanical properties. For example, conventional glass containers (without a low-friction coating) may have a coefficient of friction of greater than 0.7.

In some embodiments described herein, the coefficient of friction of the portion of the coated glass container with the low-friction coating is at least 20% less than a coefficient of friction of a surface of an uncoated glass container formed from a same glass composition. For example, the coefficient of friction of the portion of the coated glass container with the low-friction coating may be at least 20% less, at least 25% less, at least 30% less, at least 40% less, or even at least 50% less than a coefficient of friction of a surface of an uncoated glass container formed from a same glass composition.

### EXAMPLES

The embodiments described herein will be further clarified by the following examples.

### Example 1—Aqueous Treating Medium Samples

Aqueous treating medium samples were made by heating a mixtures of citric acid, ammonium bifluoride (NH₄F₂), and fine silica powder in deionized water at 45° C. for 24 hours. Each sample was saturated with silica (SiO₂). The mixtures were cooled to room temperature and filtered to remove undissolved silica. Varying amounts of aluminum chloride (AlCl₃) and sodium chloride (NaCl) salts were added to the mixtures to form the aqueous treating medium samples. The concentration of citric acid, sodium chloride, aluminum chloride, and ammonium bifluoride in each aqueous treating medium sample is given in Table 1.

TABLE 1
Aqueous Treating Medium Sample Compositions

| Sample | Citric | | | |
|---|---|---|---|---|
| Number | Acid (M) | NaCl (M) | AlCl₃ (M) | NH₄HF₂ (M) |
| Sample 1 | 1.0 | 0.0 | 0.0 | 0.026 |
| Sample 2 | 1.0 | 0.0 | 0.0 | 0.130 |
| Sample 3 | 1.0 | 0.0 | 0.0 | 0.260 |
| Sample 4 | 1.0 | 1.0 | 0.0 | 0.026 |
| Sample 5 | 1.0 | 1.0 | 0.0 | 0.130 |
| Sample 6 | 1.0 | 1.0 | 0.0 | 0.260 |
| Sample 7 | 1.0 | 2.0 | 0.0 | 0.026 |
| Sample 8 | 1.0 | 2.0 | 0.0 | 0.130 |
| Sample 9 | 1.0 | 2.0 | 0.0 | 0.260 |
| Sample 10 | 1.0 | 0.0 | 0.5 | 0.026 |
| Sample 11 | 1.0 | 0.0 | 0.5 | 0.130 |
| Sample 12 | 1.0 | 0.0 | 0.5 | 0.260 |
| Sample 13 | 1.0 | 0.0 | 1.0 | 0.026 |
| Sample 14 | 1.0 | 0.0 | 1.0 | 0.130 |
| Sample 15 | 1.0 | 0.0 | 1.0 | 0.260 |
| Sample 16 | 1.0 | 0.0 | 2.0 | 0.026 |
| Sample 17 | 1.0 | 0.0 | 2.0 | 0.130 |
| Sample 18 | 1.0 | 0.0 | 2.0 | 0.260 |
| Sample 19 | 1.0 | 0.167 | 0.333 | 0.026 |
| Sample 20 | 1.0 | 0.167 | 0.333 | 0.130 |
| Sample 21 | 1.0 | 0.167 | 0.333 | 0.260 |
| Sample 22 | 1.0 | 0.333 | 0.667 | 0.026 |
| Sample 23 | 1.0 | 0.333 | 0.667 | 0.130 |
| Sample 24 | 1.0 | 0.333 | 0.667 | 0.260 |

### Example 2-Etching Glass Articles with the Aqueous Treating Medium Samples

Ion-exchanged Valor® glass pharmaceutical vials from Corning Incorporated were contacted with each Aqueous Treating Medium Sample listed in Table 1. Each vial was etched in a bath of the aqueous treating medium sample for 24 hours at room temperature. Afterwards, each vial was rinsed with deionized water and stored in deionized water.

The surface morphology of each vial was characterized using images of the vials captured under top-down illumination. A relative intensity of light scattered from each vial was measured based on the greyscale intensity of the image of the vial. The relative intensity of light scattered from each vial is included in Table 2.

TABLE 2
Relative Intensity of Light Scattered from each Vial

| Sample Number | Relative Intensity |
|---|---|
| Sample 1 | 32.489 |
| Sample 2 | 33.594 |
| Sample 3 | 34.584 |
| Sample 4 | 32.046 |
| Sample 5 | 37.741 |
| Sample 6 | 39.355 |
| Sample 7 | 33.154 |
| Sample 8 | 34.144 |
| Sample 9 | 41.385 |
| Sample 10 | 32.489 |
| Sample 11 | 31.490 |
| Sample 12 | 31.490 |
| Sample 13 | 32.046 |
| Sample 14 | 31.490 |
| Sample 15 | 32.046 |
| Sample 16 | 32.092 |
| Sample 17 | 32.046 |
| Sample 18 | 32.092 |
| Sample 19 | 33.530 |
| Sample 20 | 31.490 |
| Sample 21 | 34.256 |
| Sample 22 | 35.177 |
| Sample 23 | 33.200 |
| Sample 24 | 34.739 |

Vials that were etched in salt-free or aluminum chloride containing aqueous treating medium samples (Samples 1-3 and 10-18) appeared smooth and were comparable to a reference vial that was not contacted with an aqueous treating medium sample. Vials that were etched in an aqueous treating medium sample including sodium chloride (Samples 4-9) included non-uniform, macroscopic deposits on the surface of the vial that contacted the aqueous treating medium. The density and size of these deposits increased as the concentration of ammonium bifluoride increased. For example, the vial etched by Sample 6 included larger deposits on the vial surface than the vial etched by Sample 4. Vials that were etched with the mixed salt aqueous treating medium samples where the concentration of ammonium bifluoride was 0.26 M (Samples 21 and 24) exhibited macroscopic deposits; however, when the concentration of ammonium bifluoride was 0.13 M or 0.026 M (Samples 19-20 and 22-23) the surface of the vial appeared to be smooth.

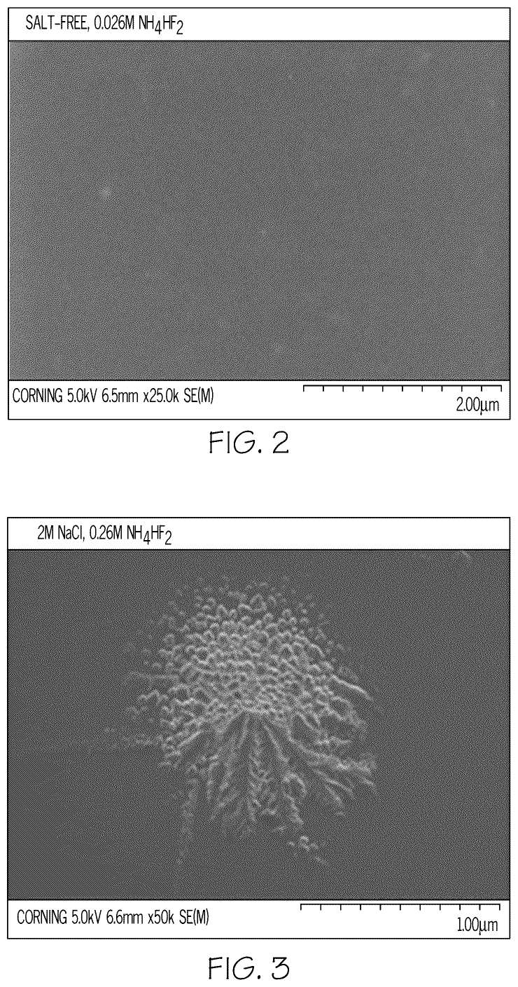

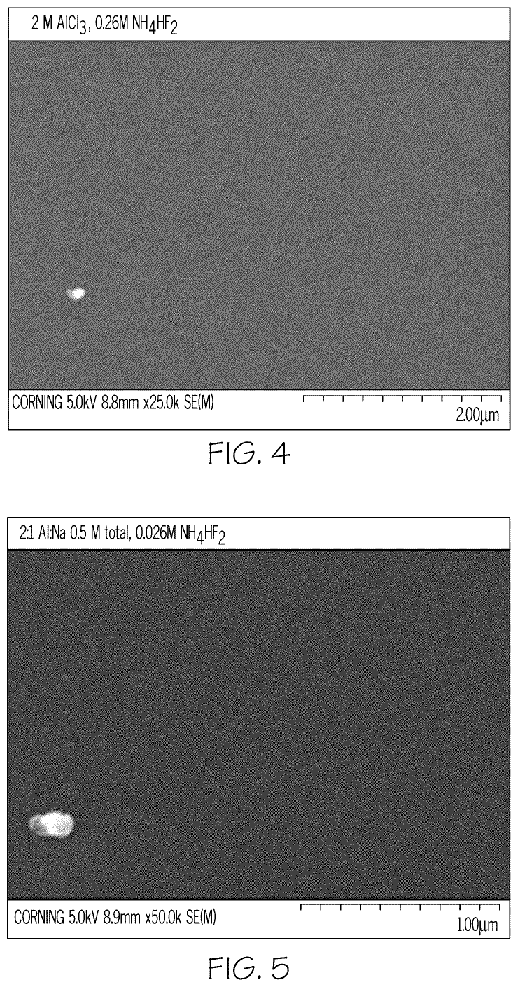

The surface morphology of vials etched by the aqueous treating medium samples was observed by scanning electron microscopy (SEM). FIG. 2 depicts a SEM image of the surface of a vial etched by Sample 1 of the aqueous treating medium. FIG. 3 depicts a SEM image of the surface of a vial etched by Sample 9 of the aqueous treating medium. FIG. 4 depicts a SEM image of the surface of a vial etched by Sample 18 of the aqueous treating medium, and FIG. 5 depicts a SEM image of the surface of a vial etched by Sample 19 of the aqueous treating medium. The macroscopic deposits observed on the vials etched by Sample 9 of the aqueous treating medium were identified as crystalline formations with a composition similar to the base glass. The vial etched with mixed salt solutions of Sample 19 had non-uniformly distributed pits on the treated surface of the vial indicative of removal of glass material from the surface of the glass.

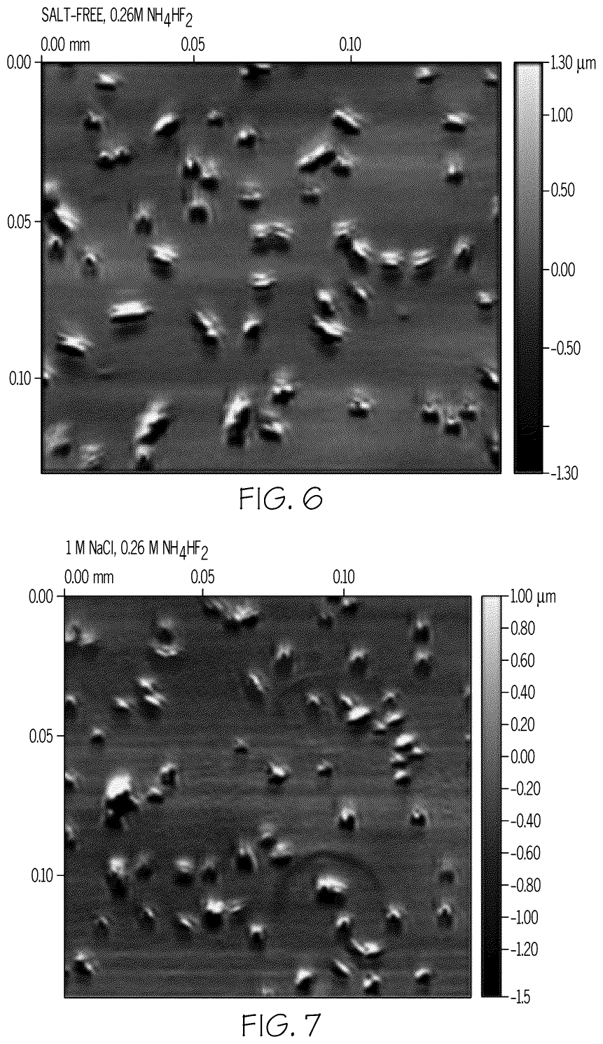

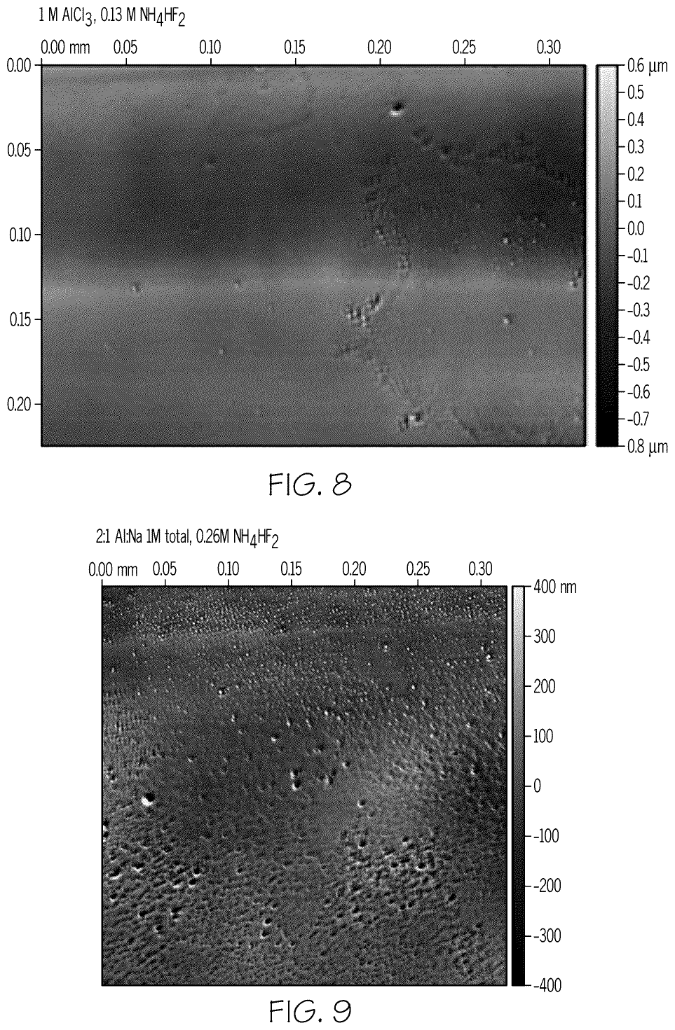

The surface morphologies of the vials etched by samples of the aqueous treating medium were quantified by confocal imaging. FIG. 6 depicts a confocal image of the surface of a vial etched by Sample 1 of the aqueous treating medium. FIG. 7 depicts a confocal image of the surface of a vial etched by Sample 9 of the aqueous treating medium. FIG. 8 depicts a confocal image of the surface of a vial etched by Sample 17 of the aqueous treating medium, and FIG. 9 depicts a confocal image of the surface of a vial etched by Sample 24 of the aqueous treating medium. A statistical analysis of the roughness of the surfaces revealed a high sensitivity of the vials' surface to the interactions between the concentration of ammonium bifluoride and the ratio of aluminum chloride and sodium chloride salts in the aqueous treating medium.

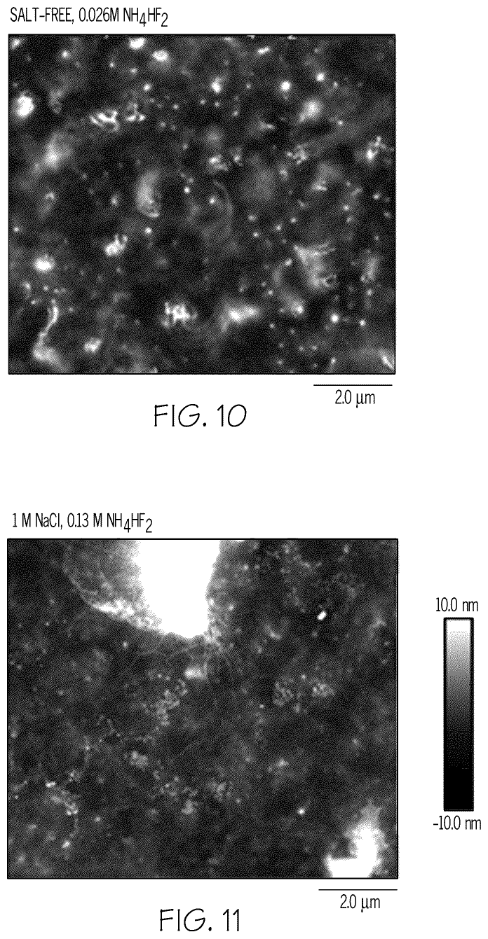

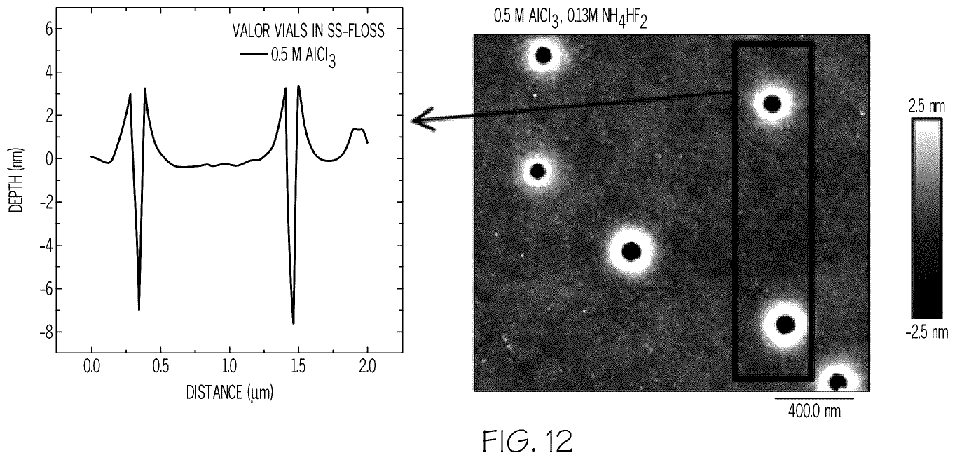

The surfaces of vials treated with samples of the aqueous treating medium were analyzed by atomic force microscopy (AFM). Generally, AFM enables the characterization of feature sizes with a spatial resolution of about 10 nm. FIG. 10 depicts an AFM image of the surface of a vial etched by Sample 1 of the aqueous treating medium. FIG. 11 depicts an AFM image of the surface of a vial etched by Sample 5 of the aqueous treating medium. FIG. 12 depicts an AFM image of the surface of a vial etched by Sample 11 of the aqueous treating medium. Additionally, FIG. 12 depicts a plot of the depth and height of the silica deposits and depressions on the surface of the vial etched by Sample 11. Vials etched by samples of the aqueous treating medium that were salt free (Samples 1-3), the thickness of deposited particulates was about 10 nm. Vials etched by samples of the aqueous treating medium that included aluminum (Samples 10-24) resulted in pits with a depth of about 10 nm.

### Example 3—Coating Glass Articles Treated with the Aqueous Treating Medium Samples

Ion exchanged Valor® glass pharmaceutical vials were etched in aqueous treating medium samples 1, 25, and 26 for 24 hours at room temperature. Aqueous treating medium samples 25 and 26 were made by the procedure described in Example 1. The composition of aqueous treating medium samples 1, 25, and 26, are included in Table 3.

TABLE 3
Aqueous Treating Medium Sample Compositions

| Sample Number | Citric Acid (M) | NaCl (M) | AlCl₃ (M) | NH₄HF₂ (M) |
|---|---|---|---|---|
| Sample 1 | 1.0 | 0.0 | 0.0 | 0.026 |
| Sample 25 | 1.0 | 0.25 | 0.0 | 0.026 |
| Sample 26 | 1.0 | 0.0 | 0.25 | 0.026 |

Etched vials were dip coated in a 3 wt. % solution of CP1™ Polyimide from Nexolve™. CP1™ is a colorless, fluorinated polyimide offered by that is soluble in the fully imidized form. Additionally, etched vials were dip coated in a coating including 3 wt. % CP1™ and silica nanoparticles. The silica nanoparticles had a diameter of about 20 nm and were loaded at 5 wt. % relative to the CP1™. Additionally, reference vials that were not etched with an aqueous treating medium were coated with the 3 wt. % CP1™ solution and the 3 wt. % CP1™ and silica nanoparticle solution. The coated vials were cured at a temperature of 360° C. for 15 minutes.

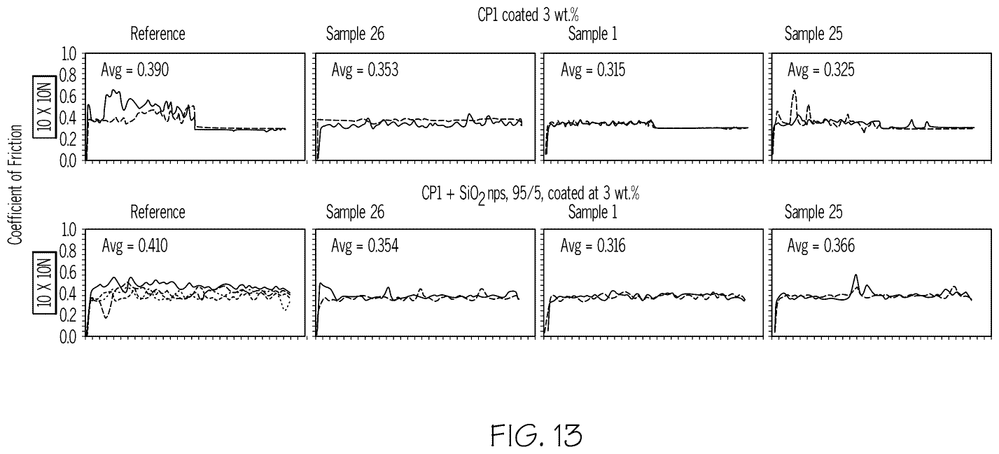

The coefficient of friction of the coated vials was determined under a 10×10 N scratch test condition. Specifically, two vials were mounted normal relative to each other. One vial was traversed at 45° while applying a specified normal force to the other vial, and the coefficient of friction was measured. The coefficient of friction was measured at 50% relative humidity and ambient temperature. The normal force was 10 N for 10 repeated scratches. The coefficient of friction data for each of the vials is depicted in FIG. 13. Additionally, the average coefficient of friction for each vial is listed in Table 4. Vials that were etched by an aqueous treating medium had lower coefficients of friction than the reference vials.

TABLE 4
Coefficient of Friction

| Sample Number | CP1 Coating | CP1 + SiO₂ Coating |
|---|---|---|
| Reference (None) | 0.390 | 0.410 |
| Sample 1 | 0.315 | 0.356 |
| Sample 25 | 0.325 | 0.366 |
| Sample 26 | 0.353 | 0.354 |

The present disclosure is directed to various embodiments of an aqueous treating medium, methods for making aqueous treating medium, and methods for using aqueous treating medium. In embodiments, the aqueous treating medium comprises water, an acid, a salt, a fluoride-containing compound, and silica, where the aqueous treating medium is saturated with silica. The aqueous treating medium may be operable to impart a texture to the surface of a glass article treated with the aqueous treating medium. The texture may enhance the adhesion of a coating to the glass article, which may reduce the coefficient of friction of the glass article.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. An aqueous treating medium comprising:
water;
an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, wherein a concentration of the acid in the aqueous treating medium is from 0.5 M to 1.5 M;
a salt, wherein a concentration of the salt in the aqueous treating medium is from greater than 0 M to 2 M;
a fluoride-containing compound selected from the group consisting of: HF, NaF, NH₄HF₂, and combinations thereof, wherein a concentration of the fluoride-containing compound in the aqueous treating medium is from 0.026 M to 0.26 M; and
silica, wherein the aqueous treating medium is saturated with silica.

2. The aqueous treating medium of claim 1, wherein the acid comprises citric acid.

3. The aqueous treating medium of claim 1, wherein the salt comprises at least one of an alkali salt, sodium chloride, and aluminum chloride.

4. The aqueous treating medium of claim 1, wherein the salt comprises sodium chloride and aluminum chloride.

5. The aqueous treating medium of claim 4, wherein the ratio of aluminum to sodium is from 1:1 to 3:1.

6. The aqueous treating medium of claim 1, wherein the fluoride-containing compound comprises NH₄HF₂.

7. The aqueous treating medium of claim 1, wherein the acid comprises citric acid, the salt comprises sodium chloride, aluminum chloride or a combination thereof, and the fluoride-containing compound comprises NH₄HF₂.

8. A method for treating a glass article, the method comprising contacting a surface of a glass article with an aqueous treating medium to form a treated surface of the glass article, wherein:
the glass article comprises silica;
the aqueous treating medium comprises:
water;
an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, wherein a concentration of the acid in the aqueous treating medium is from 0.5 M to 1.5 M;
a salt, wherein a concentration of the salt in the aqueous treating medium is from greater than 0 M to 2 M;
a fluoride-containing compound selected from the group consisting of: HF, NaF, NH₄HF₂, and combinations thereof, wherein a concentration of the fluoride-containing compound in the aqueous treating medium is from 0.026 M to 0.26 M; and
silica, wherein the aqueous treating medium is saturated with silica; and
the aqueous treating medium etches silica from the surface of the glass article and deposits silica onto the surface of the glass article.

9. The method of claim 8, wherein the glass article is formed from a Type I, Class A or a Type 1, Class B glass according to ASTM Standard E438-92.

10. The method of claim 8, wherein the glass article is formed from a borosilicate glass.

11. The method of claim 8, wherein the glass article is an ion-exchange-strengthened glass article comprising a surface compressive stress layer.

12. The method of claim 8, wherein the glass article is a glass container comprising a sidewall at least partially enclosing an interior volume, the sidewall having an exterior surface.

13. The method of claim 12, wherein the aqueous treating medium contacts the exterior surface of the sidewall.

14. The method of claim 8, wherein contacting the glass article with the aqueous treating medium occurs for a time from 5 minutes to 72 hours.

15. The method of claim 8, wherein contacting the glass article with the aqueous treating medium occurs at a temperature from ambient temperature to 50° C.

16. The method of claim 8, wherein the method further comprises rinsing at least the treated surface of the glass article with deionized water.

17. The method of claim 8, wherein the treated surface of the glass article comprises silica deposits and the silica deposits have a height from greater than 0 nm to 20 nm and a diameter from greater than 0 nm to 50 nm.

18. The method of claim 8, wherein the method further comprises applying a low-friction coating to the treated surface of the glass article.

19. A method of making an aqueous treating medium, the method comprising:
heating a mixture comprising water; an acid selected from the group consisting of: HCl, HBr, HNO₃, H₂SO₄, H₂SO₃, H₃PO₄, H₃PO₂, HOAc, citric acid, tartaric acid, ascorbic acid, EDTA, methanesulfonic acid, toluenesulfonic acid, and combinations thereof, a fluoride-containing compound selected from the group consisting of: HF, NaF, NH₄HF₂, and combinations thereof; and silica powder; to a temperature of from 25° C. to 95° C.;
cooling the mixture to ambient temperature;
filtering undissolved silica powder from the mixture; and
adding one or more salts to the mixture to form the aqueous treating medium.

20. The method of claim 19, wherein the silica powder comprises silica particles having a particle size from 100 nm to 1000 nm.
